(19) United States
(12) Patent Application Publication
(10) Pub. No.: US 2010/0061321 A1
(43) Pub. Date: Mar. 11, 2010

(54) METHOD OF SCHEDULING PACKETS

(75) Inventors: Emilio CALVANESE STRINATI, Grenoble (FR); Dimitri Ktenas, Fontaine (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: COMMISSARIAT A L' ENERGIE ATOMIQUE, Paris (FR)

(21) Appl. No.: 12/505,082

(22) Filed: Jul. 17, 2009

(30) Foreign Application Priority Data
Jul. 21, 2008 (FR) 08 54930

(51) Int. Cl. H04W 72/12

(52) U.S. Cl. 370/329

(57) ABSTRACT

The invention relates to a method of scheduling packets in a multi-access telecommunication system sharing a plurality of transmission resources. The packets relating to the various accesses are classed (110) in a first category of urgent packets (Qᵤ) and in a second category of non-urgent packets (Qₙ_{_{—}}^{u}). The packets of the first category form the subject of a first scheduling (120) and of an allocation of the said resources according to this first scheduling (125). The packets of the second category thereafter form the subject of a second scheduling (130) and of an allocation of the remaining resources, according to this second scheduling (135).

### TECHNICAL FIELD

The present invention relates to a method of scheduling packets, in particular for a multi-access wireless telecommunication system.

### PRIOR ART

Multi-access telecommunication systems make it possible to share transmission resources between various users so as to provide each of them with a separate transmission channel.

Known in particular are the techniques of TDMA (Time Division Multiple Access), FDMA (Frequency Division Multiple Access) and CDMA (Code Division Multiple Access) allocating respectively time intervals, frequencies/frequency intervals, or access codes to the various users. It is also conventional to combine these access control techniques. For example, an OFDMA system (Orthogonal Frequency Division Multiplexing Access) combines access based on frequency division (FDMA) and access based on time interval division (TDMA). In such a system each user is dynamically assigned, for each time interval, a set of sub-carriers (chunk) of an OFDM multiplex on which he can transmit his data.

In certain cases the telecommunication system offers a plurality of services, for example real-time services such as voice over IP (VoIP) and/or services for transferring data exhibiting different quality of service (QoS) profiles. The access control system may then also allow the various services of a user to access the transmission resources.

Access control can be performed by allocating dedicated resources to each user. Alternatively, the data packets of various users and/or of various services compete to access common transmission resources. For example, in a cellular telecommunication system, the base station can share time intervals (time slots), frequencies and/or spread spectrum sequences for transmitting data packets to the various users or UEs (User Equipments) or indeed to various services.

The order in which the various users or services have access to the resource is determined by a packet scheduler.

Several methods of scheduling packets are known in the prior art. For example, the method termed MCI (Maximum Channel to Interference ratio or Max C/I) or the method termed PF (Proportional Fairness) both call upon monitoring of the state of the channel (Channel State Monitoring). The first method assigns at each transmission interval the resource to the user or to the users having the best channel state, so as to obtain a maximum instantaneous total throughput. The second makes it possible to secure a balance between a criterion of maximum throughput and a criterion of equity between the various users: it guarantees that a user, having on average a better channel state than the others, achieves a higher mean throughput over the long term.

The aforementioned two scheduling methods (MCI, PF) nevertheless do not take into consideration the constraints of quality of service (QoS) of the various users. In a general manner, here the expression quality of service is understood to mean a characteristic of a certain performance level of a data stream, such as a binary throughput, a binary or packet error rate, a maximum latency or jitter time. The MCI scheduling method can furthermore result in a user who does not have a good channel state over a certain time period being denied access to the resource during the whole of this period (user starvation).

Certain methods of scheduling packets have been proposed in an attempt to comply with specific quality of service constraints. For example, the method of scheduling termed EDF (Earliest Deadline First) takes into account the real-time constraints required by certain applications (VoIP or videostreaming for example) by assigning a higher priority to a packet the closer its dispatch deadline. A packet scheduling algorithm of EDF type is described in patent US-B-230923.

The EDF scheduling method nevertheless presents the drawback of not maximizing the instantaneous total throughput, since its decision metric does not take account of information about the state of the channel, nor of offering any satisfactory compromise solution in the case of system overload.

A method of scheduling packets taking into account at one and the same time the real-time constraints of the streams as well as the maximization of the instantaneous total throughput of the users has been proposed in the article by M. Andrews et al. entitled “Providing quality of service over a shared wireless link” published in IEEE Communications Magazine, vol. 39, No. 2, February 2001, pp 150-154. This scheduling method known by the acronym MLWDF (Modified Largest Weighted Deadline First) guarantees that the packet transmission delay is less than a threshold value with a certain degree of probability.

The MLWDF method makes it possible to process in one and the same system streams subject to a real-time constraint, termed RT (Real Time) streams, as well as streams not subject to such a constraint, termed NRT (Non Real Time) streams. Nevertheless, the practical implementation of the MLWDF method turns out to be tricky since the choice of the parameters (delay thresholds, throughput thresholds) can substantially affect the performance of the system.

Another scheduling method capable of handling RT streams and NRT streams at one and the same time has been described in the article by S. Ryu et al. entitled “Urgency and efficiency based packet scheduling algorithm” published in Proceedings of the Int'l Conf. On Communications, 2005, vol. 4, pp. 2279-2785. This method, known by the acronym UEPS (Urgency and Efficiency based Packet Scheduling), has been proposed within the framework of an OFDMA system. It implements a packet scheduling rule based on utility functions dependent on the characteristics of the traffic and the set of users who are active at a given moment in the network. Here again, the choice of the utility functions strongly conditions the effectiveness of the system.

The aim of the present invention is to propose a method of scheduling packets for a multi-access telecommunication system, capable of processing at one and the same time the RT and NRT streams of the users, offering better performance in terms of satisfying traffic loading while being less sensitive to a choice of parameters than the prior art methods.

### DESCRIPTION OF THE INVENTION

The present invention is defined by a method of scheduling packets in a multi-access telecommunication system sharing a plurality of transmission resources. The packets relating to the various accesses are classed in a first category of urgent packets (Qᵤ) and in a second category of non-urgent packets (Qₙ_{_{—}}^{u}), the packets of the first category forming the subject of a first scheduling and of an allocation of the said resources according to this first scheduling, and then the packets of the second category forming the subject of a second scheduling and of an allocation of the remaining resources according to this second scheduling.

According to a first variant, an urgent or non-urgent character is assigned to service classes of the various users, a packet being classed in the first category if the class to which it belongs is of urgent character and in the second category otherwise.

According to a second variant, a packet is classed in the first category if its time to live (TTL) is less than a predetermined threshold value (Th). Advantageously, different threshold values (Th₁, . . . , Th_{N}) are provided for various service classes of the users of the system, a packet belonging to a service class (Cₙ) being classed in the first category if its time to live (TTL) is less than the threshold value associated with this class.

According to a third variant, a packet is classed in the first category if it belongs to a stream whose mean throughput calculated over a time window is greater than a predetermined threshold value (R_{Th}).

According to a first embodiment, the first and second schedulings are performed according to one and the same packet scheduling method.

The said scheduling method can then be of the “Maximum Channel to Interference ratio” type or of the “Proportional Fairness” type.

According to a second embodiment, the first and second schedulings are performed according to distinct packet scheduling methods.

The first scheduling can then be performed according to a scheduling method of “Earliest Deadline First” type and the second scheduling according to a scheduling method of the “Maximum Channel to Interference ratio” type.

Alternatively, the first scheduling can be performed according to a scheduling method of “Earliest Deadline First” type and the second scheduling according to a scheduling method of the “Proportional Fairness” type.

### BRIEF DESCRIPTION OF THE DRAWINGS

Other characteristics and advantages of the invention will become apparent on reading a preferential embodiment of the invention given with reference to the appended figures among which:

FIG. 1 schematically represents a method of scheduling packets according to the invention;

FIG. 2A illustrates the respective performance of known scheduling methods and of a scheduling method according to the invention in a first type of scenario;

FIG. 2B illustrates the respective performance of known scheduling methods and of a scheduling method according to the invention in a second type of scenario.

### DETAILED DESCRIPTION OF PARTICULAR EMBODIMENTS

Once again we adopt a standpoint within the framework of a multi-access telecommunication system where a plurality of users and/or of applications have access to common transmission resources. A typical exemplary use of the invention is that of an OFDMA system where the resources are constituted, at each transmission interval (TTI), by intervals of sub-carriers (frequency chunks). Nevertheless the present invention can generally apply to any multi-access telecommunication system sharing transmission resources between the various accesses, and in which system, for each access, the data are transmitted in the form of packets.

The idea underlying the present invention is to class the various packets into a first category corresponding to the urgent packets and a second category corresponding to the non-urgent packets, the packets of the first category having priority with respect to those of the second category. The packets belonging to the first category form the subject of a first scheduling and are allocated transmission resources in the order in which they have been scheduled. The packets belonging to the second category thereafter form the subject of a second scheduling and are assigned the resources not already allocated in the order in which they have in their turn been scheduled.

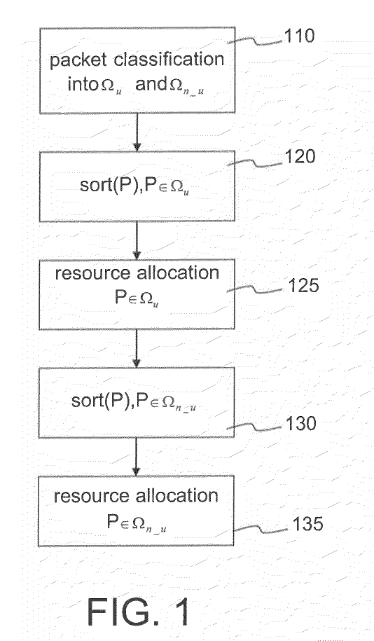

FIG. 1 schematically represents a method of scheduling packets according to the invention.

The packets relating to the various accesses, that is to say the packets of or destined for the various users and/or pertaining to various services are classed in the first and the second categories designated respectively by Ωᵤ and Ωₙ_{_{—}}^{u} in step 110.

The classing of the packets in the aforementioned two categories can be performed in various ways. For example, the system can routinely assign an “urgent” character to a certain service class. Subsequently, all the packets belonging to such a service will inherit the “urgent” character and will be classed in the first category. In the same manner, certain service classes can from the outset be considered not to have any urgency character. In this case, all the packets pertaining to such a service will be classed routinely in the second category.

Another type of classing operates directly on the packets. For example the packets can be classed as a function of their respective lifetimes or TTL (Time To Live). More precisely, a packet will belong to the first category if its lifetime is less than a predetermined threshold Th and will belong to the second category otherwise. In a more general manner, it will be possible to provide various values of thresholds Th₁, . . . , Th_{N} for various service classes C₁, . . . , C_{N}, a packet of class Cₙ will belong to the first category if its lifetime is such that TTL≦Thₙ and will belong to the second category otherwise.

It will be possible to express the threshold Th or the various thresholds Th₁, . . . , Th_{N} in terms of percentage(s) of the maximum TTL value. It will also be possible to determine the threshold Th adaptively or otherwise on the basis of a histogram of the TTL values of the various packets. In the case where several thresholds Th₁, . . . , Th_{N} are provided for various service classes, these thresholds can be obtained in a similar manner through histograms of TTL values in these various classes.

Another type of classing calls upon the mean throughput of the stream to which the packet belongs. More precisely, if a stream exhibits a greater mean throughput, calculated over a time window, than a predetermined threshold value, R_{Th}, a packet belonging to this stream will be classed in the first category.

In step 120, the packets of Ωᵤ are scheduled and the transmission resources are allocated to them at 125 according to this scheduling. In step 130, the packets of Ωₙ_{_{—}}^{u} are scheduled and the transmission resources not yet allocated are allocated to them at 135.

The scheduling of the packets of the first category and that of the packets of the second category can be performed according to identical or distinct scheduling methods.

According to a first embodiment, the two scheduling methods are identical for the two categories of packets. For example, a scheduling method not taking into account the quality of service, such as the MCI or PF method, will be used.

According to a second embodiment, the two scheduling methods are chosen to be distinct. For the packets of the first category, a scheduling method taking into account only the real-time constraint, for example the EDF method, will advantageously be opted for. Thus, among the packets considered to be urgent, a hierarchy of the urgency will be taken into account in the scheduling. Conversely, for the packets of the second category it will be possible advantageously to opt for a scheduling method aimed at maximizing the total throughput (maximum throughput) of the system independently of the quality of service constraints, for example an MCI or PF method.

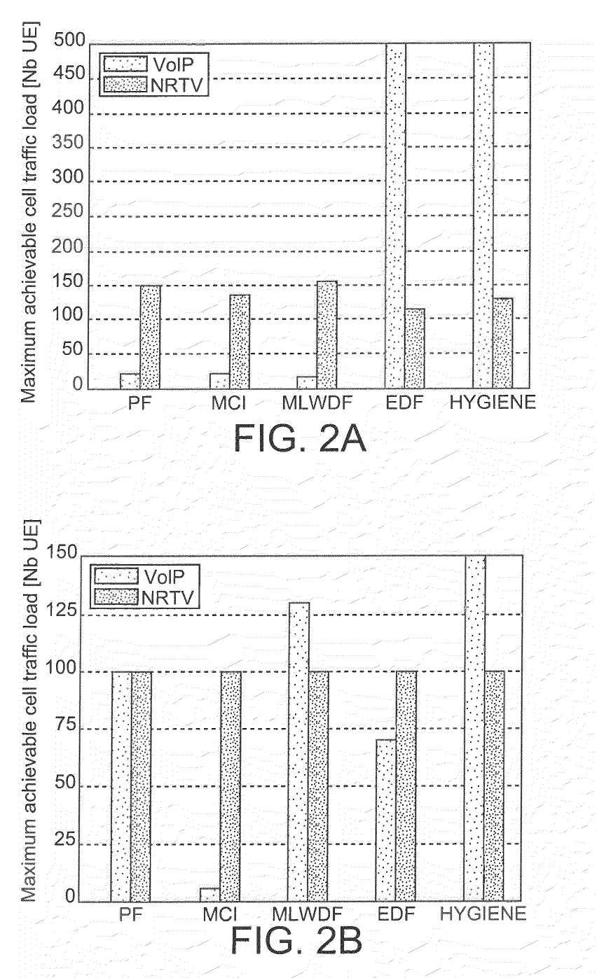

FIGS. 2A and 2B make it possible to compare the respective performance of the PF, MCI, MLWDF, EDF methods and a scheduling method according to the present invention (designated by the acronym HYGIENE), for two different scenarios. In the case illustrated, the scheduling method corresponds to the second embodiment with an EDF method for the packets of the first category and an MCI method for the packets of the second category. The threshold Th has been fixed at 40 ms.

The multi-access telecommunication system envisaged here is a cellular system comprising a base station and a plurality of items of user equipment (UEs) distributed randomly and uniformly in the cell. For each user, the data stream is of real time (RT) or non real time (NRT) type.

In the first scenario, it has been assumed that the data streams of the users of the cell could only be a single real time type, namely, in the case illustrated, either voice over IP (VoIP), or near real time video (NRTV).

In the second scenario, it has been assumed that, within the cell, real time data streams of different types could coexist, namely, in the case illustrated, VoIP and NRTV streams. Stated otherwise the real-time traffic within the cell is mixed: VoIP or NRTV.

FIGS. 2A and 2B indicate the maximum traffic load of the cell, expressed in terms of number of users, for the PF, MCI, MLWDF, EDF scheduling methods and the scheduling method according to the invention (HYGIENE). More precisely, the maximum load of the cell is defined as the maximum number of users such that 95% of the users are satisfied, a VoIP service or NRTV service user being considered to be satisfied if his packet error rate is less than 2% and if the transfer time in the scheduler is respectively less than 50 ms and 100 ms. The results have been averaged over 100 independent simulations, each simulation comprising a random draw of the positions of the equipment followed by 100 seconds of activity of the network. At each new transmission interval (TTI) a new draw of the characteristics of the transmission channels of the various users is performed.

FIG. 2A shows that for VoIP service users, the maximum traffic load in the cell is obtained with the EDF method and the method according to the invention. On the other hand, NRTV service users, the differences in performance between the various scheduling methods are relatively small, the lowest result being obtained with the EDF method.

FIG. 2B shows that if there are NRTV service users (fixed here at 100) and VoIP service users in the cell at one and the same time, the maximum traffic load in the cell is obtained with the method according to the invention. The lowest result is on the other hand obtained with the MCI scheduling method.

1. Method of scheduling packets in a multi-access telecommunication system sharing a plurality of transmission resources, characterized in that the packets relating to the various accesses are classed (110) in a first category of urgent packets (Qᵤ) and in a second category of non-urgent packets (Qₙ_{_{—}}^{u}), the packets of the first category forming the subject of a first scheduling (120) and of an allocation of the said resources according to this first scheduling (125), and then the packets of the second category forming the subject of a second scheduling (130) and of an allocation of the remaining resources according to this second scheduling (135).

2. Scheduling method according to claim 1, characterized in that an urgent or non-urgent character is assigned to service classes of the various users, a packet being classed in the first category if the class to which it belongs is of urgent character and in the second category otherwise.

3. Scheduling method according to claim 1, characterized in that a packet is classed in the first category if its time to live (TTL) is less than a predetermined threshold value (Th).

4. Scheduling method according to claim 3, characterized in that different threshold values (Th₁, . . . , T_{N}) are provided for various service classes of the users of the system, a packet belonging to a service class (Cₙ) being classed in the first category if its time to live (TTL) is less than the threshold value associated with this class.

5. Scheduling method according to claim 1, characterized in that a packet is classed in the first category if it belongs to a stream whose mean throughput calculated over a time window is greater than a predetermined threshold value (R_{Th}).

6. Scheduling method according to one of the preceding claims, characterized in that the first and second schedulings are performed according to one and the same packet scheduling method.

7. Scheduling method according to claim 6, characterized in that the said same scheduling method is of the “Maximum Channel to Interference ratio” type or of the “Proportional Fairness” type.

8. Scheduling method according to one of claims 1 to 5, characterized in that the first and second schedulings are performed according to separate packet scheduling methods.

9. Scheduling method according to claim 8, characterized in that the first scheduling is performed according to a scheduling method of “Earliest Deadline First” type and that the second scheduling is performed according to a scheduling method of the “Maximum Channel to Interference ratio” type.

10. Scheduling method according to claim 8, characterized in that the first scheduling is performed according to a scheduling method of “Earliest Deadline First” type and that the second scheduling is performed according to a scheduling method of the “Proportional Fairness” type.
